(19) United States
(12) Patent Application Publication
(10) Pub. No.: US 2007/0206502 A1
(43) Pub. Date: Sep. 6, 2007

(54) CASCADE CREDIT SHARING FOR FIBRE CHANNEL LINKS

(75) Inventors: KREG A. MARTIN, Los Gatos, CA (US); Shahe H. Krakirian, Palo Alto, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: BROCADE COMMUNICATIONS SYSTEMS, INC, SAN JOSE, CA (US)

(21) Appl. No.: 11/747,671

(22) Filed: May 11, 2007

Related U.S. Application Data
(62) Division of application No. 10/348,067, filed on Jan. 21, 2003.
Application No. 10/348,067 is a continuation-in-part of application No. 10/207,361, filed on Jul. 29, 2002, now abandoned.

(51) Int. Cl. H04L 12/00

(52) U.S. Cl. 370/235; 370/252; 370/412

(57) ABSTRACT

A switch having a higher speed port, one or more slower speed ports, a larger buffer memory and numerous larger counters to achieve higher speed and longer range of communication. In one embodiment a larger switch having a larger buffer memory and larger counters connects to a smaller switch having a smaller buffer memory and smaller counters, the larger switch practically expanding the buffer memory and counters in the smaller switch. A combination of several counters can also avoid buffer overrun in any switches in the frame flow path due to the mismatch between the counter capabilities, the limitations of physical buffer spaces or the mismatch between transmission speeds. In another embodiment, the buffer spaces in several switches can be aggregated or cascaded along a frame path so that there are enough credits to maintain a high-speed transmission over a long distance.

### CROSS-REFERENCE TO RELATED APPLICATIONS

This application is a divisional of U.S. application Ser. No. 10/348,067, filed Jan. 21, 2003, which is a continuation-in-part application of the U.S. patent application Ser. No. 10/207,361, filed on Jul. 29, 2002.

This application is related to and incorporates by reference, U.S. patent application Ser. No. 10/062,861, entitled “Methods and Devices for Converting Between Trunked and Single-Link Data Transmission in a Fibre Channel Network,” by Kreg A. Martin, filed Jan. 31, 2002.

### BACKGROUND OF THE INVENTION

1. Field of the Invention

This invention relates generally to network switching devices and more particularly to Fibre Channel switching devices having higher speed ports and lower speed ports and switching devices cascading credits from one switch to another through the fabric.

2. Description of the Related Art

The Fibre Channel family of standards (developed by the American National Standards Institute (ANSI)) defines a high speed communication interface for the transfer of large amounts of data between a variety of hardware systems such as personal computers, workstations, mainframes, supercomputers, storage devices and servers that have Fibre Channel interfaces. Use of Fibre Channel is proliferating in client/server applications which demand high bandwidth and low latency I/O such as mass storage, medical and scientific imaging, multimedia communication, transaction processing, distributed computing and distributed database processing applications. U.S. Pat. No. 6,160,813 to Banks et al. disclosed one Fibre Channel switch system, which is hereby incorporated by reference.

With the ever increasing demand for higher speed communication, even at the 1 Gb/sec or 2 Gb/sec speed, the existing Fibre Channel switches still cannot fully satisfy the high speed communication need. The current switches have limited port-to-port transmission speeds at about 2 Gb/sec or 3 Gb/sec. The current switches also have a limited transmission distance between two ports, in the neighborhood of 100 km. One factor that is limiting the transmission distance is the limited buffer spaces, or buffer-to-buffer credits which represent the buffer spaces, in a switch available to a communicating port to temporarily store data frames in transmit. Another factor that is limiting the transmission distance is the capacities of the credit counters that track the usage of these buffer spaces or credits.

Whenever a port is connected to another port, a receiver in the port will advertise the number of buffer spaces the receiver has available for buffering frames, i.e. the number of credits available for the transmitter in the other side of the inter-switch link. The transmitter will set its transmitter credit counter (TCC) to the number of credits advertised by the receiver. Whenever the transmitter transmits a frame to a receiver, its transmitter credit counter is decreased by one. When the receiver receives the frame, a receiver credit counter (RCC) is increased by one. When the receiving port confirms the receipt of a frame by the next unit in the data path, the receiving port sends back a credit and reduces the receiver credit counter (RCC) by one. When the transmitting port receives the credit, the transmitter credit counter (TCC) is increased by one. When all the credits in the transmitter credit counter are used, i.e. the transmitter credit counter is zero, the transmitter cannot send more frames until some credits that are returned by the receiving port are received, i.e. the transmitter credit counter returns to a positive number.

The more buffer space a receiver has, the more credits the receiver can advertise to a transmitter. The more credits a transmitter has, the lower the chance that the transmitter has to stop and wait for more credits returning from the receiver. Thus the more buffer space, or the more credits available, the faster the effective transmission speed and the longer the distance can be.

The Ser. No. 10/062,861 application discloses a new switch with ports having a port-to-port speed up to 10 Gb/sec and a large buffer memory in the switch.

It is desirable to have a new switch that can communicate at a higher speed and over a longer distance. It is also desirable to have a new switch not only compatible with the existing switches, e.g. having bridging mechanisms to bridge the different transmission speed of different switches within a fabric, but also extend the functionality of the existing switches to preserve the value of the existing Fibre Channel network.

### SUMMARY OF THE INVENTION

A switch in one embodiment of the present invention has a higher speed port, one or more slower speed ports, a larger buffer memory and numerous larger counters to achieve higher speed and longer range of communication. In one embodiment of the present invention, when a larger switch having a larger buffer memory and larger counters connects to a smaller switch having a smaller buffer memory and smaller counters, the larger switch can practically expand the buffer memory and counters in the smaller switch. A combination of several counters can also avoid buffer over-run in any switches in the frame flow path due to the mismatch between the counter capabilities, the limitations of physical buffer spaces or the mismatch between transmission speeds. In another embodiment, the buffer spaces in several switches can be aggregated or cascaded along a frame path so that there are enough credits to maintain a high speed transmission over a long distance.

### BRIEF DESCRIPTION OF THE DRAWINGS

A better understanding of the invention can be had when the following detailed description of the preferred embodiments is considered in conjunction with the following drawings, in which:

FIG. 1 is a block diagram of a typical Fabric with connecting devices.

FIG. 2 is a block diagram of an E-chip in 10 G mode, with one 10 G-port and four GP-ports according to one embodiment of the present invention.

FIG. 3 is a block diagram of an E-chip in long haul mode with four GP-ports, according to a second embodiment of the present invention.

FIG. 4 is an illustration of a typical frame.

FIG. 5 is a block diagram of an embodiment of present invention with two E-chips of FIG. 2 in a 10 G mode.

FIG. 6 is a block diagram of another embodiment of present invention with two E-chips in a long haul mode.

FIG. 7 is a block diagram of a third embodiment of the present invention with multiple E-chips in a long haul mode.

FIG. 8 is a block diagram of new high speed/long distance multiple-port switch using multiple E-chips and existing multiple port switches.

### DESCRIPTION OF THE PREFERRED EMBODIMENT

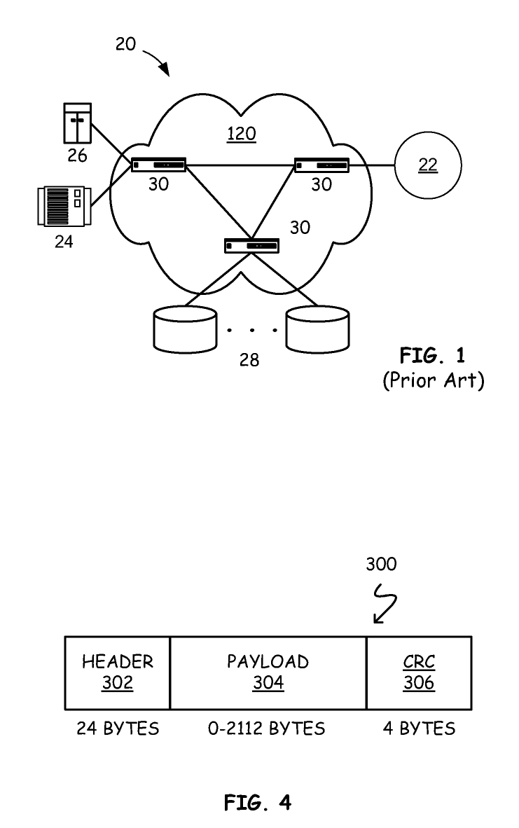

FIG. 1 depicts a typical Storage Area Network (SAN) utilizing a Fibre Channel network 20. The fabric 120 may comprise one or more switches 30. Three switches are shown. Many devices or nodes, such as a storage unit 24, a server 26, database disk drive 28 and a loop 22 (itself comprised of devices, not shown) are connected to the fabric 120. Any devices in the fabric 120 can communicate to any other devices in the fabric 120.

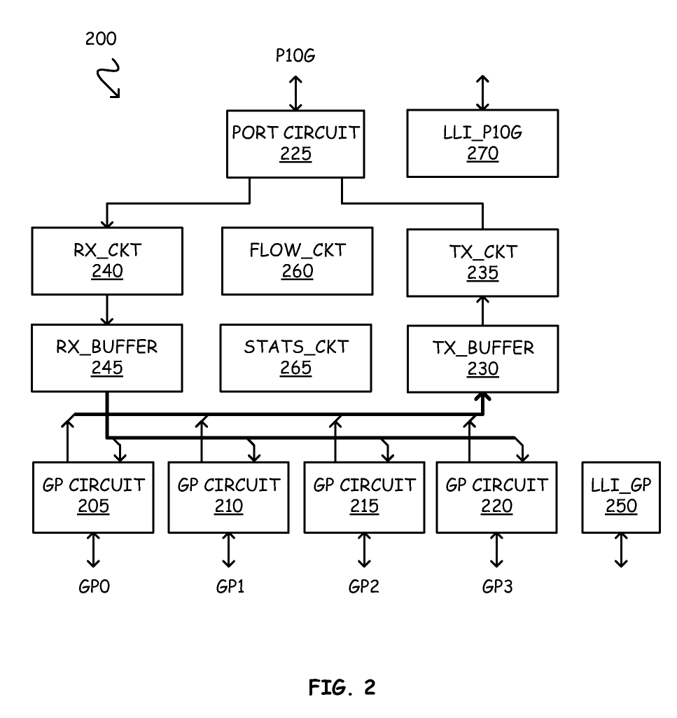

FIG. 2 shows a high level block diagram for one embodiment 200 of the present invention, called an E-chip, in 10 G or high speed mode. E-chip 200 has one 10 G-port 225 and four GP-ports, 205, 210, 215 and 220. A 10 G-port can communicate at nominal 10 Gbps (Gigabit per second) with another port that supports such a high communication speed. A GP-port can communicate at a lower speed than a 10 G-port, such as 1, 2 or 3 Gbps. The E-chip 200 has several buffer memories and many circuit groups. The buffer memories include TX buffer 230 and RX buffer 245. The RX buffer 245 is preferably large, at approximately 1 Mbyte. The circuit groups include four types of circuits: transmitter circuit 235, receiver circuit 240, flow control circuit 260 and statistics circuit 265. The E-chip 200 may also have a GP Low Level Interface (LLI_GP) 250 and a 10 GP Low Level Interface (LLI_P10 G) 270 for interconnection controls between the E-chip 200 and the port interface modules.

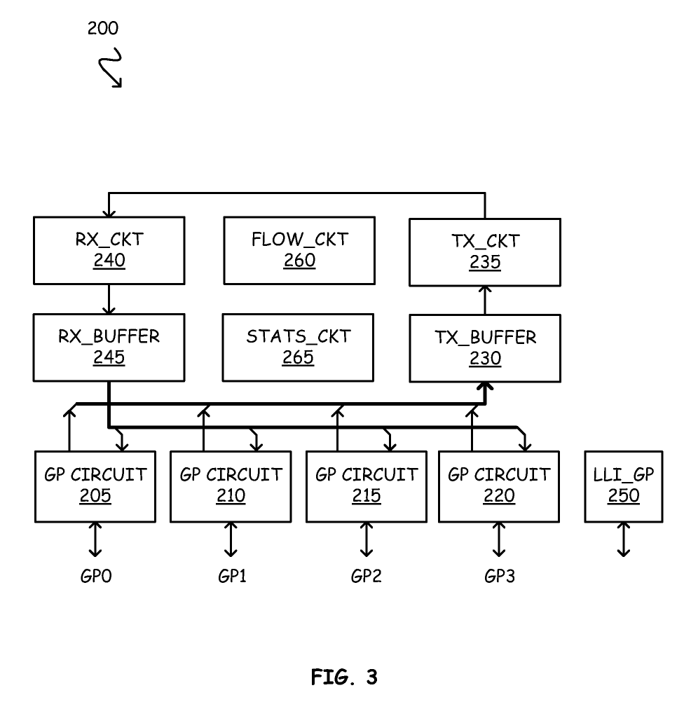

FIG. 3 shows the E-chip 200 configured in long haul mode. As shown, the transmit circuit 235 is connected to the receive circuit 240, with the port circuit 225 and the LLI_P10 G circuit 270 omitted. Thus, the information may travel through an E-chip in at least two ways: between GP-ports and the 10 G-port, or between the GP-ports, depending on the configuration of the E-chip 200. The 10 G-port is utilized where a higher speed link is desired, while only the GP-ports are utilized when the transmission distance is more important. For more details on the 10 G mode, please refer to the previously incorporated “Methods and Devices for Converting Between Trunked and Single-Link Data Transmission in a Fibre Channel Network” application.

The 10 G-port can be divided into four Path Numbers, each representing a virtual GP-port, each of which has a speed closer to a physical GP-port. Each physical GP-port and the virtual GP-port can further be divided into many virtual channels. Nodes in a fabric may use the virtual channels as “dedicated connections” between them to communicate with each other. The E-chip has enough counters and buffer spaces allocated to each GP-port, virtual GP-port or Path Numbers, or virtual channels as appropriate for the particular counter or buffer space.

The four GP-ports may also be “trunked,” i.e. combined, to form a port with a higher speed. The four GP-ports may be “trunked” in any combination of 2, 3, or 4 ports in a 10 G mode (i.e. a single 4-port trunk, two 2-port trunks or a single 3-port trunk with a single non-trunked port etc.) For example, in a single 4-port trunk, all four GP-ports are combined to form one logical high-speed port, very close to the 10 G-port, such that the transmission speed between the GP-port side and the 10 G-port side matches. In a long haul mode when only the GP-ports are being utilized, the GP-ports may be trunked in pairs.

A unit of information transferred through the fabric is called a frame. FIG. 4 describes a typical frame 300. A frame 300 includes a standard header 302, payload 304 and CRC 306. The payload 304 in a frame can vary, from zero bytes to over two thousand bytes. The size of a frame becomes important in an E-switch because an E-switch has a large buffer memory, the RX buffer 245. As discussed above, one buffer space large enough to temporarily store a frame is counted as one credit in buffer space or credit management. The size of a buffer memory in a receiver in terms of number of credits is advertised by the receiver during the initial configuration between a transmitter-receiver link.

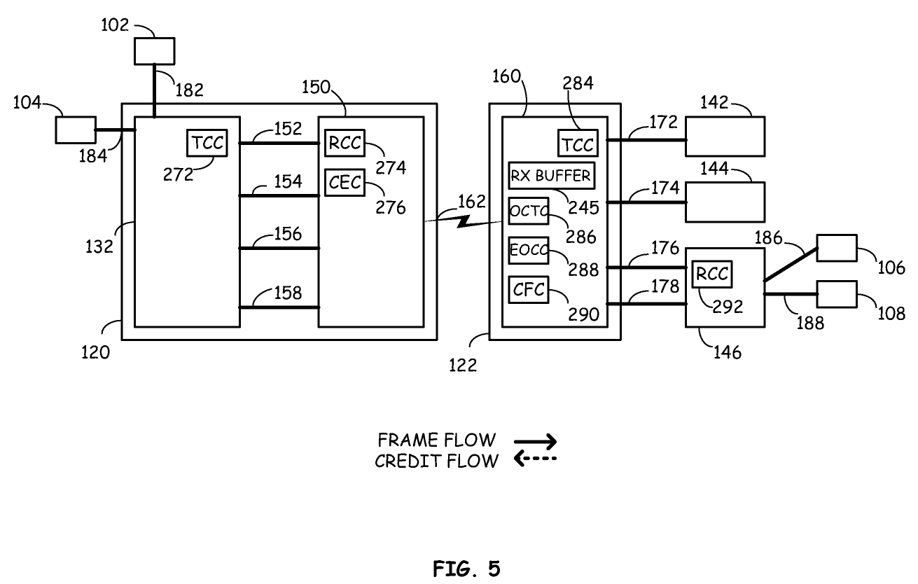

FIG. 5 depicts an embodiment of the present invention where two switches having E-chips 150 and 160 are employed in a fabric. On the left side, network nodes 102, 104 and etc. are connected to the fabric, through a B-chip 132, over links 182 and 184. The B-chip 132 is preferably a mini switch with, for example, eight GP-ports. Four GP-ports in B-chip 132 are connected to the four GP-ports in the E-chip 150 through inter-switch links (ISLs) 152, 154, 156 and 158 to form switch 120. The four GP-ports in the E-chip 150 may also connect to four GP-ports in a separate switch or GP-ports in up to four different switches if desired.

E-chip 150 is further connected to E-chip 160, which forms switch 122, through a 10 G-ISL 162, which is a inter-switch link between two 10 G-ports. Similar to E-chip 150, each of the four GP-ports in E-chip 160 may connect to four GP-ports in the same switch or different switches. In this example, the four GP-ports in E-chip 160 are connected through ISLs 172, 174, 176 and 178 to four GP-ports of three switches 142, 144 and 146. Each of the switches 142, 144 and 146 may connect many devices. Two nodes 106 and 108 connected to switch 146 with links 186 and 188 are shown.

To illustrate the operation of an embodiment of the present invention, the communication between node 102 and node 106 will be discussed below. Frame traffic may flow generally both ways, from left to right or from right to left. For example, from left to right: frames from node 102 in the left flow through the fabric to node 106 on the right side. From right to left, frames from node 108 in the right flow to node 104 on the left. The frame flow from left to right and the flow from right to left are independent. The flow scheme for each direction may be different to best suit needs of the particular frame flow or the flow schemes may be the same in both directions for ease of implementation. For simplicity and clarity, only the frame flow from the left to right is discussed. An upstream device is a device on the left. A downstream device is a device on the right.

Accompanying the frame flow, i.e. the data transferring, there is a corresponding credit flow, i.e. the flow of the control signals confirming the transfer of frames from a receiver to the next device in the flow (or use of the frame in an end node). The flow of credits is in the opposite direction of the frame flow, from the right to left in the following discussion.

To manage the frame and credit flow, a number of counters are used in the illustrated embodiment of the current invention. A transmitter credit counter (TCC) 272 in B-chip 132 associated with the port on ISL 152 is shown. Corresponding to TCC 272, there is a Receiver Credit Counter (RCC) 274, which is on the E-chip 150 side of ISL 152. Another counter, called the Credit Extension Counter (CEC) 276 associated with the ISL 152 in E-chip 150 is shown. There can be many more equivalent counters in E-chip 150 and the B-chip 132 associated with VCs, other ISLs and with ports which are not shown. Any of these counters may be dedicated to a single logical flow path, a physical ISL, or shared among logic flow paths or physical links. For example, in the preferred embodiment, a TCC is provided for every VC of every port and a RCC is provided for every VC of every port. Thus there are 48 TCCs and 48 RCCs in the preferred embodiment.

On E-chip 160, the data receiving side of the 10 G-ISL 162 for this example, there are buffers and counters, RX buffer 245, TCC 284, OCTC 286, and CFC 290, associated with the communication between nodes communicating through E-chips 150 and 160, e.g. node 102 and node 106. In one preferred embodiment, an additional counter EOCC 288 may be used together with OCTC 286. Their structures and use will be discussed in more detail later. E-chip 160 and switch 146 are connected through ISLs 176 and ISL 178. In switch 146, the receiving side of the ISLs 176 and 178 in this example, there is an RCC 292.

In operation, a frame from node 102 to node 106 will travel from node 102, to B-chip 132, ISL 152, E-chip 150, 10 G-ISL 162, E-chip 160, ISL 174, switch 144 and finally arrive at node 106. Once node 106 receives a frame from node 102, and processes it, making the buffer in node 106 that held the frame available again, node 106 will return an acknowledgement signal confirming the receipt of the frame. The acknowledgement, which may be represented by as a credit, travels backward through all the links and switches to node 102.

The actual flow path taken by the frames or credits from node 102 through node 106 is not of concern of this invention. An actual physical flow path through any inter-switch links may be dedicated or multiplexed, such as using virtual channels or different links in a trunk of ISLs. One physical ISL may be divided into many logical virtual channels, each of which may have its own queue, priority, credit allocation and management and flow control etc. A logical flow path is a path for frames traveling from a source, such as a node in a fabric, to its destination, such as another node. There may be other switches in between the source and the destination with different inter-switch links. Within a logical flow path, there are transmitters and receivers, just as in a real flow path. There are frame flow and credit flow and flow controllers, which manage the credits. One implementation of a logical flow path is a virtual channel in an inter-switch link, which operates just like a real physical inter-switch link. When virtual channels are used in a physical ISL, the one high speed ISL can operate as several lower speed ISLs. In the reverse, many physical ISL can be combined, or “trunked” to effectively make a high speed ISL from several slow speed ISLs.

More details on virtual channels is disclosed in U.S. application Ser. No. 09/929,627, filed Aug. 13, 2001, entitled “Quality of Service Using Virtual Channel Translation,” by David C. Banks and Alex Wang. More details on trunking is disclosed in U.S. application Ser. No. 09/872,412, filed Jun. 1, 2001, entitled “Link Trunking and Measuring Link Latency in Fibre Channel Fabric,” by David C. Banks, Kreg A. Martin, Shunjia Yu, Jieming Zhu and Kevan K. Kwong. Both of these applications are incorporated by reference.

The following discussion about flow path is only regarding the exemplary single logical flow path between node 102 and node 106. Any buffers or credits available in any switches referred to below are only the buffer space or credits in those switches available for this particular logical flow path in discussion unless otherwise noted. The total available buffer space and credits are usually more than what is available for a particular logic flow path. Some buffer space or credits and credit counters may be dedicated to a particular logical path, or others may be shared by all the logical paths within a physical path.

Still referring to FIG. 5, the transmitting device node 102 is a source of frames. The receiving device, here the node 106, is a sink of frames. As for credits, it is the opposite: node 102 is a sink and node 106 is a source. At the end of a particular data transmission session, the number of frames send by node 102, the number of frames received by node 106, the number of credits sent by node 106 and the number of credits received by node 102 are all the same. The switches in between are neither sources nor sinks for either frames or credits. The switches have no frames at the beginning and the end of any data transmission session. The number of credits in the transmitter of a switch is the same at the beginning and the end of any data transmission session, although the number many change during the transmission session. The number of credits in the transmitter of a switch is determined by the amount of credits advertised by the downstream switches or devices.

Within the E-chip, there are generally two types of frame flows. One is buffered, where a frame received by the E-chip has a frame buffer allocated to temporarily store the frame in the E-chip RX buffer 245 (i.e. credit for that frame was previously advertised based on the availability of the frame buffer in RX buffer 245). The frame is stored in the RX buffer 245 memory for a period of time that may be longer than the time necessary for receiving or transmitting a frame. The other type of frame flows is unbuffered, where a frame received by the E-chip has a frame buffer in the downstream device (e.g. 146) (i.e. credit for that frame was previously advertised based on the availability of the frame buffer in device 146). The frame received by the E-chip is retransmitted out of the E-chip as soon as the frame is received, sometimes even before the entire frame is received by the E-chip. In unbuffered frame flow the E-chip is acting as a First In First Out (FIFO) conduit. Each logical flow path can have only one type of frame flow through the E-chip, while the different logical flow paths through an E-chip generally do have different types of frame flow.

The unbuffered flow is generally used for control frames, where the data flow requires low bandwidth and the overall throughput is not of concern.

Buffered flow is generally used for bulk, usually unicast, data transfer, where a large number of frames need to be transferred. There is no interruption intrinsic to the data flow during the transmission, so the highest possible throughput with no interruption is desired. To achieve the highest possible throughput, data frames usually need to be buffered in the receiver. As discussed earlier, the more credits a receiver has, the longer the distance between the transmitter and the receiver while still maintaining a certain frame transmission rate. Therefore, in long distance transmission, buffered flow is usually used.

In the fabric shown in FIG. 5, for the frame flow through E-chip 150 from B-chip 132 towards E-chip 160, the frame flow is unbuffered. Frame flow going though E-chip 160 to switch 146 for a given logical flow path may be buffered or unbuffered, depending on the bandwidth requirements of that logical flow path.

In one embodiment of the present invention, the credits advertised by a receiver from one switch can be cascaded through the fabric to upstream switch. In the fabric shown in FIG. 5, credits advertised by a logical receiver in switch 146 can be accepted by the corresponding transmitter in E-chip 160, as usual. When the logical receiver in E-chip 160 is connected to a logical transmitter in E-chip 150, the receiver will advertise not only the credits available to it in E-chip 160 (i.e. buffer space in E-chip 160, available for the logical receiver) as usual, it may also add the amount of credits from downstream switches, here from switch 146. For example, if the receiver in switch 146 advertises 30 credits, and the receiver in E-chip 160 has 500 credits available to it, then it will advertise 530 credits to the transmitter in E-chip 150. Here the receiver in E-chip 160 is running in a buffered frame flow mode. If it is running in a unbuffered mode, when it has only a FIFO buffer, then it will only advertise 30 credits, the amount of credits it gets from downstream, to the transmitter in E-chip 150, the upstream transmitter.

To implement the above scheme to fully utilize the available large buffer space and counters, more counters, besides the conventional TCCs and RCCs, are used. One set of actions to increment and decrement those counters is listed in Table 1.

TABLE 1
The operation of the counters: increment or decrement

| | Switches | | | | | | | |
|---|---|---|---|---|---|---|---|---|
| | 132 | 150 | 150 | 160 | 160 | 160 | 160 | 146 |
| Counters | TCC | RCC | CEC | OCTC | EOCC | CFC | TCC | RCC |
| | 272 | 274 | 276 | 286 | 288 | 290 | 284 | 292 |
| Frame sent downstream | −1 | | | +1 | −1 | | −1 | |
| Frame received from | | +1 | | −1 | | | | +1 |
| upstream | | | | | | | | |
| Credit sent upstream | | −1 | −1 | | +1 | −1 | | −1 |
| Credit received from | +1 | | +1 | | | +1 | +1 | |
| downstream | | | | | | | | |

−1 means decrement the counter;
+1 means increment the counter.

CEC (Credit Extension Counter)

One advantage of one embodiment of the present invention is to expand the credit counter capacities of existing switches. One example is the credit extension counter CEC 276 in E-chip 150 which effectively extends capacity of the transmission credit counter TCC 272.

TCCs in many existing switches, such as B-chips in Silkworm 3800, a switch commercially available from Brocade Communications Systems, Inc., are 6-bit counters, which can only count up to 63. The buffer memory space available to a receiver in such a switch is about 64 kbyte, or less than 30 credits for maximum length frames. So a TCC in a B-chip is more than adequate when a B-chip connects to another B-chip, which can advertise at a maximum less than 30 credits. When a B-chip connects to an E-chip, which may advertise hundreds or thousands of credits (or more, as will be discussed later), then the TCC in the B-chip is inadequate. In one embodiment of the present invention, a new counter CEC, used in combination with the existing TCC, to relieve such problem. A CEC in an E-chip is a 16-bit counter, with 15 counting bits, which can count up to 32768. The CEC is used in combination with the TCC to provide the capability to count a larger number of transmitted outstanding frames.

As soon as a frame sent from B-chip 132 reaches E-chip 150, E-chip 150 can immediately send a credit back to B-chip 132, without waiting for a credit returning from a downstream device, a switch or a node. Whenever E-chip 150 sends back a credit to B-chip 132, CEC 276 decrements. Whenever E-chip 150 receives a credit from downstream switch 160, CEC 276 increments. The initial value of CEC 276 is equal to the number of credits advertised by the downstream device minus the maximum capacity of the TCC in B-chip 132. For example, if the downstream device advertises 530 credits and the maximum capacity of the TCC is 63, the initial CEC value is 467. When CEC 276 goes down to zero, E-chip 150 can no longer send credit back to B-chip 132. When CEC 276 goes down to zero, there are at least as many buffer spaces left in E-chip 150 or downstream switches as the number of credits in B-chip 132. This ensures that there is always buffer space available to buffer frames sent by the B-chip 132. The RCC 274 tracks the number of frames received by E-chip 150 whose credits have not returned back. Wherever E-chip 150 receives a frame, RCC 274 increments. Whenever E-chip 150 returns a credit, RCC 274 decrements. Whenever RCC 274 is zero, E-chip 150 will not return any credit, because no frame has been sent by B-chip 132 and received by E-chip 150. Thus, since TCC 272 gets credits from CEC 276 soon after E-chip 150 receives frames from B-chip 132, TCC 272 is not likely to run out of credit until CEC 274 runs out of credit, so CEC 274 effectively enlarges the size of TCC 272 to the combined size of CEC 274 and TCC 272.

In some embodiments, TCC 272, RCC 274 and CEC 276 are associated with a particular logic flow path. That is for each logic flow path, there is a set of TCC, RCC and CEC on B-chip 132 and E-chip 150 respectively. Thus in the preferred embodiment, there are 48 CECs, one for each VC for each logic flow path. When the GP ports are trunked in some embodiments, then one logic flow path encompasses several physical links (e.g. port-to-port links). A CEC is still associated with one VC but shared among several ports. In some other embodiments of the current invention, TCC 272 and RCC 274 are associated with one logic flow path in the ISL 152 (e.g. one VC or one ISL), but CEC 276 is shared among all logical/physical links between B-chip 132 and E-chip 150, i.e. ISLs 152, 154, 156 and 158. In these embodiments, there is a set of TCC and RCC for each logic flow path, but only one common CEC for all logic flow paths. The function of CECs in later embodiments are the same as in the earlier embodiments, although in the later embodiments, one larger shared counter replaces several smaller dedicated counters, and the initial value of the CECs in these two groups of embodiments are different. The following is an example illustrating a different initialization of CEC, when CEC is shared among 4 pairs of TCCs and RCCs. Still assuming the downstream device advertises 530 credits for the all the links between B-chip 132 and E-chip 150 (rather than for one logic flow path), and the maximum capacity of each TCC is 63. Then CEC is set to 530−4×63=278.

OCTC, CFC (Outstanding Credit Threshold Counter, Credit Forwarding Counter)

The 10 G-port is much faster than a GP-port, even faster than the 4 trunked GP-ports in many conditions. In a buffered frame flow mode, credits from the downstream switch, i.e. switch 146, may not be advertised to upstream switch, here E-chip 150. So all frames sent by E-chip 150 and received by E-chip 160 are buffered in E-chip 160. E-chip 160 will forward these frames to downstream switch 146 at its convenience, which will be dictated by the credits advertised by switch 146. When TCC 284 runs out of credits, which is set by credit advertised by switch 146, it cannot send more frames. Therefore, E-chip 160 or switch 146 cannot be overrun by E-chip 150. Additional speed throttling or bridging is not necessary.

In an unbuffered frame flow mode, however, it is possible that E-chip 150 can send more frames than E-chip 160 can accept. Therefore it is necessary to have a mechanism to bridge the speed difference. In another embodiment of the present invention, a Credit forwarding counter CFC 290 and an Outstanding Credit Threshold Counter OCTC 286 are used, in part for this purpose. In a preferred embodiment, an Excess Outstanding Credit Counter EOCC 288 may also be used.

Credit forwarding counter CFC 290 in E-chip 160 is used to coordinate the upstream credit flow through E-chip 160 to E-chip 150. Whenever E-chip 160 receives a credit from switch 146, CFC 290 increments. Whenever E-chip 160 sends a credit back to E-chip 150, CFC 290 decrements. CFC 290 is initialized to zero. When CFC 290 reaches zero again, E-chip 160 cannot send credit to E-chip 150. The E-chip 160 is using CFC 290 or the returned credits to throttle the speed of the upstream switch down to the speed of the slower downstream switch.

OCTC 286 represents the number of frames that can be held in the buffer memory before credits to upstream devices are withheld in order to prevent buffer memory overrun. EOCC 288, when used, represents the number of outstanding credits supported by devices downstream of E-chip 160 which are advertised to devices upstream of E-chip 160.

Whenever a frame is sent downstream from E-chip 160, OCTC 286 increments and EOCC 288 decrements. Whenever a frame is received from upstream by E-chip 160, OCTC 286 decrements. Whenever a credit is sent upstream by E-chip 160, EOCC 288 increments.

When the OCTC value is less than 1, then E-chip 160 cannot send credits back upstream to E-chip 150, even if E-chip 160 has received credits back from downstream devices, such as switch 146.

Once E-chip 160 withholds credits returned from downstream devices, E-chip 150 or B-chip 132 will not have enough credit to keep sending frames down to E-chip 160. E-chip 150 will have to wait for more returned credits from E-chip 160, therefore, E-chip 160 will not be overrun.

Similar to TCC, RCC and CEC, in some embodiments, a CFC, an OCTC, and an EOCC may form a set dedicated for a particular logic flow path. In other embodiments, any one of CFC, OCTC or EOCC may be dedicated to a particular logic flow path, or shared among the logic flow paths between links of some switches. The functions of these counters are the same, whether they are dedicated for one logic flow path, or shares among several logic flow paths. The difference may be the settings of the initial values and the threshold values. The different implementations of the counters will not affect the current invention.

In some embodiments, OCTC and EOCC are associated with a particular segment. A segment is a part of the RX buffer memory dedicated to a Path Number. One E-chip may be divided into one or more paths with unique path numbers (PNs). For the E-chip shown in FIG. 5, there are four (4) GP-ports. Each GP-port is assigned to one PN if the ports are non-trunked. If the GP-ports are trunked, then one unique PN is assigned to each trunk. A segment may be a buffered segment if it is used for a buffered flow path, which is allocated to one VC of a PN. The number of maximum-sized frames that can fit in a buffered segment must be large enough to support the credits advertised through a 10 G-port for the corresponding VC. A segment may be an unbuffered segment, which can be allocated to all remaining VCs (i.e. those that are not allocated to a buffered segment). The unbuffered segment is used for unbuffered flow path. The unbuffered segment acts as a temporary FIFO for those VCs. All credits advertised through the 10 G-port for the VCs of the PN are supported by frame buffers in the devices downstream of the E-chip. The unbuffered segment has high priority access for transferring frames to the GP-ports relative to the buffered segments in order to prevent segment overrun. As indicated earlier, CFC, OCTC and EOCC are useful for unbuffered frame flow with ports having different transmission speeds, they may be used with unbuffered segments in an E-chip. In the preferred embodiment, there is a CFC is for every VC of every PN, so that there are 48 CFCs. In the preferred embodiment, there is one EOCC and one OCTC for each segment, so there can be four EOCCs and four OCTCs.

The parameters and functions used for calculating the initialization values of OCTC and EOCC when used may be as follows:

ICREDIT is the credit advertised for the flow path supported by frame buffers in the downstream devices, such as switch 146.

F_THR is Frame Count Threshold: A threshold of the number of frames that are temporarily buffered in the flow path. If the threshold is exceeded, the forwarding of credits (RDY primitives) from the GP-port to the 10 G-port may be held off in order to prevent an overrun.

GP_FRAME_RATE is the minimum rate at which maximum-sized frames can be transferred on a GP. This takes into account the inter-frame gap.

NUM_GP is the Number of GP-ports (typically 4).

XG_FRAME_RATE is the maximum rate at which maximum-sized frames can arrive from 10 GFC. This assumes a minimum inter-frame gap of one word.

UNBUF_NUM_FRAMES is the number of maximum-sized frames for which the unbuffered segment may have space reserved on a switch. UNBUF_NUM_FRAMES is calculated by the following equation in one preferred embodiment:
UNBUF_NUM_FRAMES=min(ICREDIT,(SPEED_{—}MATCH_{—}FRAMES+F_{—}THR+2*NUM_{—}GP))
Where min(a, b) is a function to return the value of the lesser of a and b.
SPEED_{—}MATCH_{—}FRAMES=roundup((ICREDIT−F_{—}THR)*SPEED_{—}INDEX)
Where SPEED_INDEX is defined below:

$$SPEED\_INDEX = 1 - \frac{GP\_FRAME \_RATE * NUM\_GP}{XG\_FRAME \_RATE}$$

Roundup(X) is a function to get the next integer greater than or equal to x.

Case 1, where the combined frame rate of all GP-ports is higher than the 10 G-port frame rate. The counters for this case may be initialized as follows:

F_THR=0

OCTC=7FFh (maximum positive value)

EOCC=0

Since the combined frame rate of all GPs is higher than the 10 G-port, the E-chip 160 cannot be overrun, and EOCC and OCTC are not necessary, so they are initialized to their extreme values.

Case 2, where the combined frame rate of all GP-ports is lower than the 10 G-port frame rate. The recommended value is calculated as follows:

F_THR may be two times the number of GP ports (in the example with four GP ports, 2×4=8) or higher otherwise and applies,
F_{—}THR=max(2*NUM_{—}GP,roundup(ICREDIT*SPEED_{—}INDEX))

The counters for this case may be initialized as follows:

OCTC=F_THR

EOCC=ICREDIT

The following numeric examples show the initialization of the OCTC and EOCC counters:

Assuming GP-ports run at a nominal 3 Gbps:

ICREDIT=32 (a downstream switch advertises 32 credits);

GP_FRAME_RATE=146.2 kframe/s

XG_FRAME_RATE=592.47 kframe/s

NUM_GP=4

Then SPEED_INDEX=0.0129

F_THR=8

SPEED_MATCH_FRAMES=1

UNBUF_NUM_FRAMES=17

OCTC=8 and EOCC=32

Another numerical example, where the GP-ports run at a nominal 2 Gbps:

Assuming ICREDIT=64 (a downstream switch advertises 64 credits);

GP_FRAME_RATE=97.47 kframe/s

XG_FRAME_RATE=592.47 kframe/s

NUM_GP=4

Then SPEED_INDEX=0.342

F_THR=22

SPEED_MATCH_FRAMES=15

UNBUF_NUM_FRAMES=45

OCTC=22 and EOCC=64

Long Haul Mode

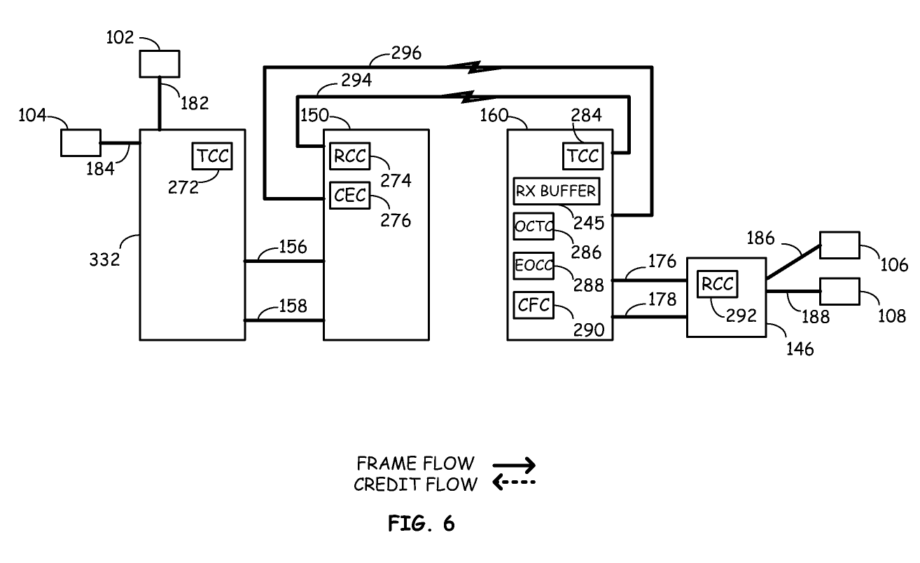

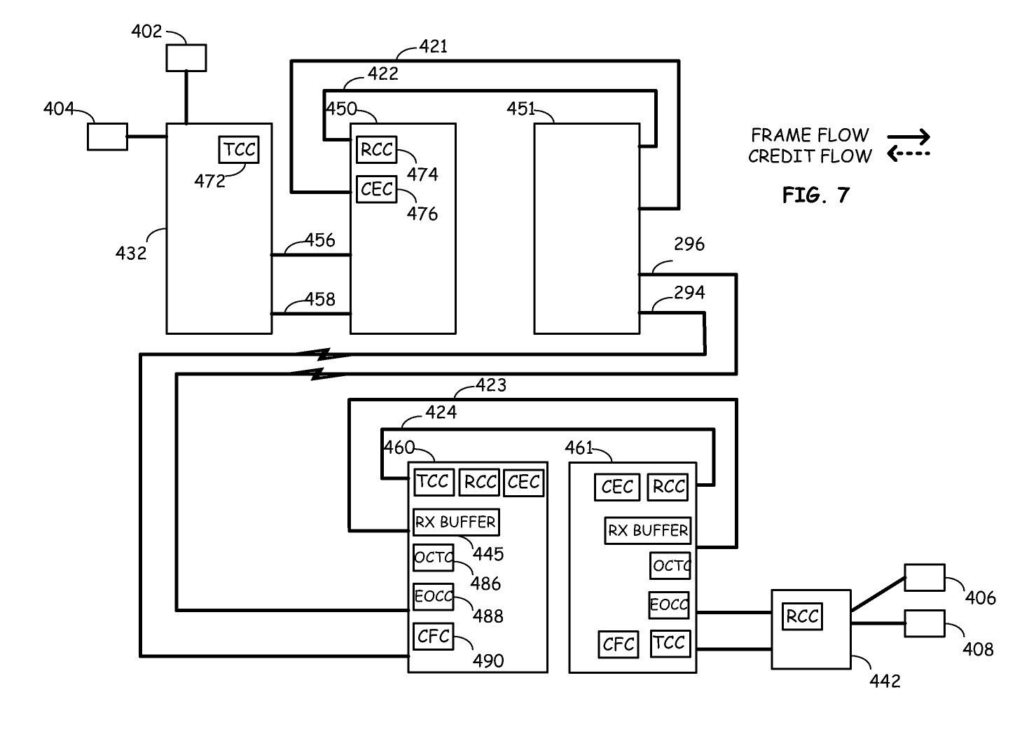

A second embodiment of the present invention where the maximum transmission speed is exchanged for maximum transferring distance, i.e. the long haul mode of operation, is shown in FIGS. 6 and 7.

In FIG. 6, two E-chips are used in long haul, so there are no 10 G-ports. Two GP-ports in E-chip 150 and two GP-ports in E-chip 160 are connected through ISLs 296 and 294. These two ISLs 296 and 294 are trunked as one link. The distance between the two switches having E-chip 150 and 160 can be very long, such as several hundred kilometers. The number of links to E-chips is reduced from four GP-ports to only two GP-ports. The available buffer spaces in the E-chips are now shared by two GP-ports.

As discussed earlier, at a certain frame transmission rate, the longer the distance, the more credit a receiver needs to advertise to the transmitter. The size of the receiver buffer needed at certain frame transmission rate for certain distance, in terms of number of frames or credit can be determined by the following formula:

$$TOTAL\_NUM \_FRAMES = roundup ( \frac{2 * dist * Gbaud * RI * 1000}{3 * MAX\_FRAME \_SIZE} ) + 8$$

Where roundup(x) is a function to get the next integer greater than or equal to x;

dist is the distance between the two communicating ports in kilometers;

Gbaud is the rate of receive link, 1.0625 for 1 Gbps, 2.125 for 2 Gbps, 3.1875 for 3 Gbps etc.;

RI is the Refractive index of the fiber, assuming 1.5 for the worst case;

MAX_FRAME_SIZE is the size of maximum length frame, which is 2148 bytes;

8 is a typical number representing the latency within a switch.

A third numerical example:

Assuming the transmission speed between the ports at 2 Gbps for 500 km, and an RI equal to 1.5, the required buffer space in the receiver is:
TOTAL_{—}NUM_{—}FRAMES=roundup(2*500*2.125*1.5*1000/3/2148)+8=503

For a typical E-chip, the buffer space can store about 500 maximum sized frames. This means that a typical E-chip has enough buffer space to support a data transmission at 2 Gbps for up to about 500 km. For longer distance transmission, a switch with more buffer space is necessary.

Credit Cascading

As shown in the last numeric example, one E-chip only has enough buffer space to sustain 500 km long transmission at a nominal 2 Gbps rate. In another embodiment of the current invention, instead of requiring one single switch or chip having a very large buffer, several chips can pool their buffer space to make one virtual chip having a very large buffer. Furthermore, this virtual chip can be flexible and expandable to whatever size necessary.

In FIG. 7, two E-chips (450, 451, 460, 461) in each switch on each side of a long distance link (294, 296) are used to make more buffer space available for the long distance communication need. E-chips 450 and 451 act as one E-chip 150 in FIG. 6 and E-chips 460 and 461 act as one E-chip 160 in FIG. 6. Similar as in FIG. 6, all of the 10 G-ports, 464, 466, 467, 468 are left unused. On the receiving side of the long haul inter-switch links 294 and 296, credit cascading is from right to left, in the direction of credit flow. In a certain logical flow path, a B-chip 442 advertises the amount of credits (assuming 30) available to the flow path to E-chip 462. This advertised credit will initialize the TCC in E-chip 461. Then the first E-chip 461 will advertise the amount of credit available to the flow path, which would be the amount of buffer space (500 credits for example) in the first E-chip 461 plus credits from B-chip 442 (30 credits), for a total of 530 credits. Similarly, the second E-chip 460 will advertise 500+530=1030 credits to E-chip 150. Thus it is clear that the transmitter in E-chip 451 can send 1030 frames without receiving any credits returned back from an end device such as 406 or 408. Therefore, the maximum distance of the long haul inter-switch link can be about 1000 km at the same nominal 2 Gbps speed as in FIG. 6. If longer distance transmission is desired, one can simply increase the number of E-chips used in one switch as in FIG. 7. The maximum distance at a predetermined speed is proportional to the number of E-chips used in the receiver side of the long haul link. In the above example, at nominal 2 Gbps, each E-chip has enough buffer space for 500 km. So if the distance desired is x km, then the number E-chips needed is roundup (x/500). For example, if the distance is 2100 km, the number of E-chips needed is roundup (2100/500)=5.

In the cascaded credit configuration, the frame flow through the E-chip is equivalent to a combination of a buffered flow and an unbuffered flow. Thus, the frame buffers required in E-chip and the counter initialization values are calculated as follows, using E-chip 460 in FIG. 7 as an example:

The frame buffers required in E-chip 460 are the sum of two parts, part (1) frame buffers advertised by it (i.e. 500 in this example) and part (2) frame buffers needed for an equivalent unbuffered flow for frame buffers advertised by the downstream devices (i.e. unbuffered flow for 530 downstream credits).

The frame buffers needed in E-chip 460 for part (1) is called BUF_NUM_FRAMES and is 500 in this example. The frame buffers needed in E-chip 460 for part (2) is called UNBUF_NUM_FRAMES, which is calculated using equations similar to the equations for the unbuffered segment in 10 G mode. One different equation is as follows:

$$SPEED\_INDEX = 1 - \frac{SND\_FRAME \_RATE}{RCV\_FRAME \_RATE}$$

where RCV_FRAME_RATE is the maximum rate at which frames may be received from the upstream device, and SND_FRAME_RATE is the minimum guaranteed rate at which frames are sent to the downstream device when credits are available. This formula for SPEED_INDEX is almost the same as used in the 10 G mode. The only difference is in the nomenclature so that the formula is more relevant to this credit cascading case.

For this example, assume that RCV_FRAME_RATE=194.94 kframe/s and SND_FRAME_RATE is 5% lower, i.e. 185.19 kframe/s, then:

SPEED_INDEX=0.05

ICREDIT in this example is 530 (sum of credits advertised by E-chip 461 and B-chip 442), therefore:

F_THR=27

SPEED_MATCH_FRAMES=26

UNBUF_NUM_FRAMES=57.

Thus, the total number of frame buffers needed in E-chip 460 is:

BUF_NUM_FRAMES+UNBUF_NUM_FRAMES=500+57=557.

The counters for this case are initialized as follows:

OCTC=BUF_NUM_FRAMES+F_THR

EOCC=ICREDIT

In this example, the counters in E-chip 460 are initialized as follows:

OCTC=500+27=527

EOCC=530

The buffer space reserved for unbuffered segment in a cascade mode is slightly larger than in a regular 10 G mode, in a preferred embodiment, as illustrated in the last example. The buffer space requirement for unbuffered segment in an E-chip is proportional to the number of credits advertised by downstream devices. The number of credits advertised by downstream devices could be very large. The total buffer space on an E-chip is fixed. Therefore, the actual advertised number of credits from an E-chip may be slightly less in a cascade long haul mode than in a 10 G mode.

The switches on either side of the long haul link shown in FIG. 7 are symmetric, i.e. each has the same number of E-chips, but that depends on the data transmission needs in the direction. For example, if data transmission in one direction is much more than the other direction, i.e. not symmetric, then the switches need not be symmetric. For example, if there are only data transmission from nodes on the left to the nodes on the right, then only one E-chip is needed on the left while there are four E-chips needed on the right side.

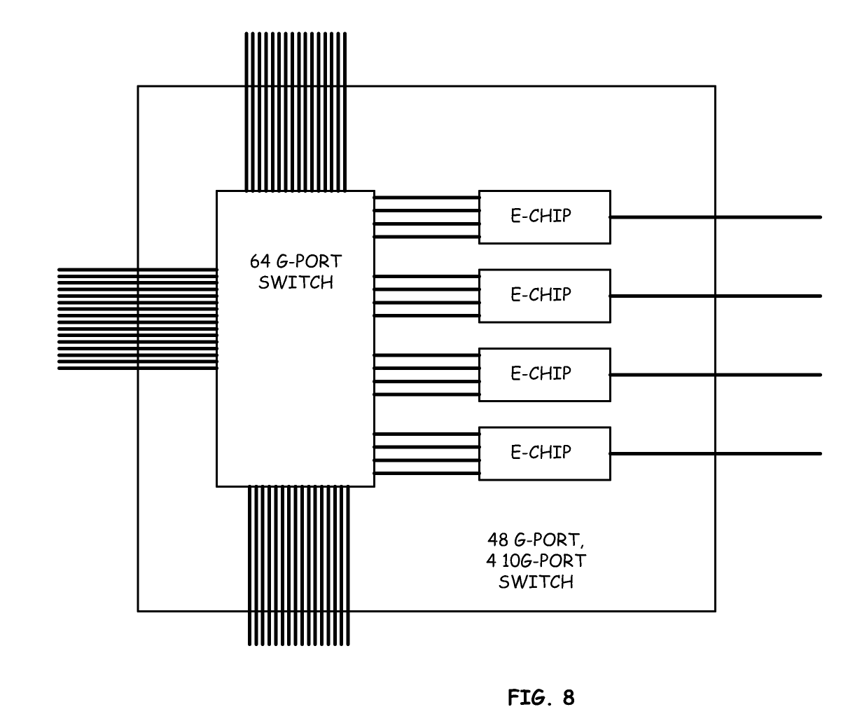

FIG. 8 depicts one new switch implementing an embodiment of the present invention. Four E-chips are connected to 16 GP-ports of a commercially available 64-port switch to make a new switch. This new switch has 48 GP-ports and 4 10 G-ports. This new switch may be used in 10 G mode to connect up to 4 10 G-ports or nodes supporting 10 G speed at one size, or 48 switches or nodes supporting 1, 2 or 3 G speed. It can also be used in long haul mode for transmission distance up to 2000 km at 2 Gbps speed.

In the above description, various counters have been described as incrementing or decrementing based on given conditions. Further, various actions or non-actions have been described as occurring based on counter values. Additionally, exemplary equations for providing initial values of the various counters have been described. It is understood that any or all of the counters could be constructed to operate in the opposite manner from that described, such operation being equivalent to the described operation. For example, the CEC could increment when credit sent upstream and decrement when credit is received from upstream. The initial value and actions or non-actions based on CEC values would then also be changed to reflect this inversion of the described counting operation. It is thus understood that various changes to the counters, related actions and initial values can be made, such as inverting the counting operation, which changes would be fully equivalent to the described operations.

Titles and subtitles used in the text are intended only as focal points and an organization tool. These titles are not intended to specifically describe the applicable discussion or imply any limitation of that discussion.

1. A method to avoid buffer overrun in a logic flow path in a Fibre Channel network including
a first switch having:
a first slow speed port;
a second fast speed port; and
a memory control module communicating with the first and the second ports;
a second switch having:
a third fast speed port connected to the second port in the first switch;
a plurality of slow speed ports;
a memory module communicating with the third port and the slow speed ports and having a plurality of buffers;
a memory control module communicating with the memory module and having a number of credits representing the buffers in the memory module in the second switch; and
first and second counters communicating with the memory control module; and
a third switch having:
a fifth slow speed port connected to a slow port in the second switch;
a sixth slow speed port;
a memory control module and communicating with the fifth port and the sixth port, the method comprising the steps of:
advertising a number of credits for a logical flow path to the first switch;
initializing the first counter to a first number;
incrementing the first counter when the fourth port receives a credit;
decrementing the first counter when the third port sends a credit; and
prohibiting the third port from sending credits when the first counter is less than one.

2. The method in claim 1, wherein the number of credits advertised to the first switch equals a number of credits in the second switch plus the number of credits advertised by the fifth port.

3. The method in claim 1, wherein the number of credits advertised to the first switch equals a number of credits advertised by the fifth port.

4. The method in claim 1, further comprising:
initializing the second counter to a second number;
incrementing the second counter when the fourth port sends a frame;
decrementing the second counter when the third port receives a frame; and
prohibiting the third port from sending credits when the second counter is less than zero.

5. The method in claim 4,
wherein the second number is determined by the following formula:
(second number)=max(8, roundup(SPEED_{—}INDEX*(the number advertised to the first switch))),
where
SPEED_INDEX=1−(total frame transmission rate out the second switch through ports other than the third port)/(total frame transmission rate into the second switch through the third port),
max (a, b, . . . ) is a function returning the largest number in the argument, and
roundup(x) is a function returning the next integer greater than or equal to x.

6. A method to increase the buffer space available to a receiver for a logical flow path on a receiving side of a long distance Fibre Channel communication network, the logical flow path having a predetermined frame transmission rate and predetermined distance and requiring a predetermined number of credits to sustain the predetermined transmission rate at the predetermined distance,
the method comprising:
selecting a type of Fibre Channel switch wherein the switch has credit counters with maximum counting capacities greater than the predetermined number and the switch has ports supporting the predetermined frame transmission speed;
determining a number n of Fibre Channel switches needed, wherein the number n equals the roundup ((predetermined number of credits)/(number of credits in one switch)), where roundup(x) is a function returning the next integer greater than or equal to x;
connecting the number of Fibre Channel in series, wherein the nth switch connects to the transmitting side through the long distance link;
the receiving port in the first switch advertising a first number of credits which is the number of credits in the first switch to the transmitting port in a second switch connected to the receiving port in the first switch, and a transmitter credit counter in the second switch is set to the first number;
the receiving port in the second switch advertising a second number of credits which is the sum of the number of credits in the second switch plus the first number advertised by the first switch;
repeating the last two steps, until the nth switch, wherein the nth switch advertising the nth number of credits which is the sum of the number of credits in the nth switch plus the (n−1)th number of credits advertised by the (n−1)th switch.

7. A Fibre Channel switch comprising:
a first port;
a second port;
a buffer memory having a plurality of buffers, communicating with both the first port and the second port; and
a control module having a plurality of credits representing the buffers, communicating with both the first port and the second port, and controlling one or more logical flow paths within the switch; and
wherein the control module is operable to advertise a first number of credit for a flow path through the first port to a third port when the third port is connected to the first port;
wherein the control module is operable to acknowledge a second number of credit advertised from a fourth port for the flow path through the second port when the fourth port is connected to the second port;
wherein the first number equals to the sum of the second number and the number of credits on the switch allocated by the control module to the flow path.
